(19) United States
(12) Patent Application Publication
(10) Pub. No.: US 2008/0031623 A1
(43) Pub. Date: Feb. 7, 2008

(54) Providing optical signal regeneration information at the control plane

(75) Inventors: Snigdho C. Bardalai, Plano, TX (US); Sifang Chu, Plano, TX (US)

Correspondence Address: BAKER BOTTS L.L.P., 2001 ROSS AVENUE, SUITE 600, DALLAS, TX, 75201-2980, US

(73) Assignee: Fujitsu Limited

(21) Appl. No.: 11/499,621

(22) Filed: Aug. 4, 2006

(51) Int. Cl. H04J 14/00

(52) U.S. Cl. 398/57

(57) ABSTRACT

According to one embodiment, providing optical signal regeneration information for an optical path includes sending a path message through the optical path. The optical path comprises a sequence of nodes of a communication network, where the sequence of nodes comprises an initiating node, a set of intermediate nodes, and a terminating node. The path message communicates optical signal regeneration information specifying optical signal regeneration for one or more regenerating nodes of the sequence of nodes. A regenerating node receives the path message. The regenerating node is configured according to the optical signal regeneration information. The configured regenerating node is operable to perform optical signal regeneration.

### TECHNICAL FIELD

This invention relates generally to the field of communication networks and more specifically to providing optical signal regeneration information at the control plane.

### BACKGROUND

An optical network uses optical signals to communicate information among the nodes of the network. As an optical signal travels through the network, however, the signal quality may degrade, reducing the ability of the signal to communicate information. To improve signal quality, the signal may be regenerated. Signals may be regenerated using amplifiers or optical-electrical-optical converters.

Performing regeneration in the network involves providing regeneration information, such as where the regeneration is to occur. Known techniques for providing the regeneration information, however, are inefficient in certain situations. It is generally desirable to have efficient techniques for providing the regeneration information.

### SUMMARY OF THE DISCLOSURE

In accordance with the present invention, disadvantages and problems associated with previous techniques for providing optical signal regeneration information may be reduced or eliminated.

According to one embodiment of the present invention, providing optical signal regeneration information for an optical path includes sending a path message through the optical path. The optical path comprises a sequence of nodes of a communication network, where the sequence of nodes comprises an initiating node, a set of intermediate nodes, and a terminating node. The path message communicates optical signal regeneration information specifying optical signal regeneration for one or more regenerating nodes of the sequence of nodes. A regenerating node receives the path message. The regenerating node is configured according to the optical signal regeneration information. The configured regenerating node is operable to perform optical signal regeneration.

Certain embodiments of the invention may provide one or more technical advantages. A technical advantage of one embodiment may be that optical signal regeneration information may be provided at the control plane. Providing the regeneration information at the control plane may be more efficient than providing the regeneration information at the management plane.

A technical advantage of another embodiment may be that the regeneration information for the regenerating nodes of an optical signal path may be provided at an initiating node of the path. A path message may communicate the regeneration information from the initiating node to each regenerating node. Providing the regeneration information at the initiating node may be more efficient than providing the information at each regenerating node.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating one embodiment of a network system for which optical signal regeneration information may be specified; and

FIG. 2 is a flowchart illustrating one embodiment of a method of providing optical signal regeneration information that may be used with the network system of FIG. 1.

### DETAILED DESCRIPTION OF THE DRAWINGS

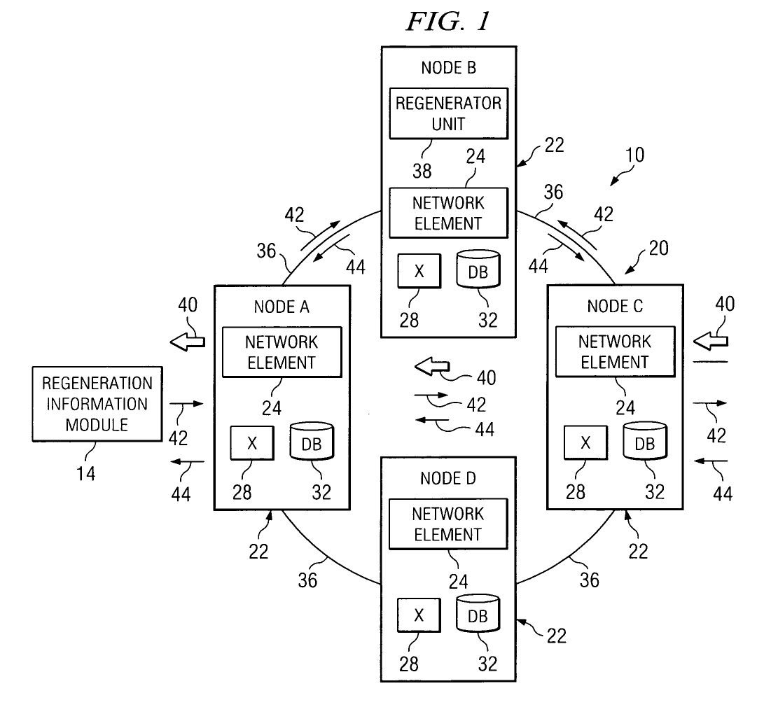

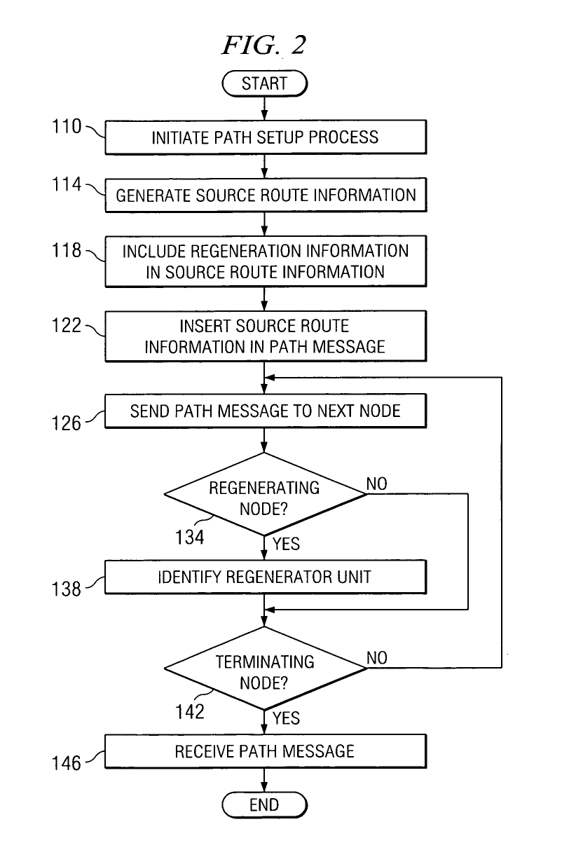

Embodiments of the present invention and its advantages are best understood by referring to FIGS. 1 and 2 of the drawings, like numerals being used for like and corresponding parts of the various drawings.

FIG. 1 is a block diagram illustrating one embodiment of a network system 10 for which optical signal regeneration information may be specified. According to the embodiment, the regeneration information may be provided at the control plane. The regeneration information may be specified at an initiating node of an optical signal path. A path message may communicate the regeneration information from the initiating node to the regenerating nodes of the optical signal path.

According to the illustrated embodiment, network system 10 communicates information using signals. A signal may refer to an optical signal transmitted as light pulses. As an example, an optical signal may have a frequency of approximately 1550 nanometers and a data rate of 10, 20, 40, or over 40 gigabits per second. A signal may comprise a synchronous transport signal (STS).

As an optical signal travels through system 10, the signal quality may degrade, reducing the ability of the signal to communicate information. To improve the signal quality, the signal may be regenerated. Signal regeneration refers to signal processing of a signal that restores the signal to substantially its original characteristics. Optical signal regeneration refers to signal regeneration of an optical signal.

A signal may communicate information in packets. A packet may comprise a bundle of data organized in a specific way for transmission, and a frame may comprise the payload of one or more packets organized in a specific way for transmission. A packet may carry any suitable information such as voice, data, audio, video, multimedia, control, signaling, other information, or any combination of the preceding. The packets may comprise any suitable multiplexed packets, such as time division multiplexed (TDM) packets.

System 10 includes devices. In general, a device may include any suitable arrangement of components operable to perform the operations of the device. As an example, a device may include logic, an interface, memory, other component, or any suitable combination of the preceding. “Logic” may refer to hardware, software, other logic, or any suitable combination of the preceding. Certain logic may manage the operation of a device, and may comprise, for example, a processor. “Processor” may refer to any suitable device operable to execute instructions and manipulate data to perform operations.

“Interface” may refer to logic of a device operable to receive input for the device, send output from the device, perform suitable processing of the input or output or both, or any combination of the preceding, and may comprise one or more ports, conversion software, or both.

“Memory” may refer to logic operable to store and facilitate retrieval of information, and may comprise a Random Access Memory (RAM), a Read Only Memory (ROM), a magnetic drive, a disk drive, a Compact Disk (CD) drive, a Digital Video Disk (DVD) drive, a removable media storage, any other suitable data storage medium, or a combination of any of the preceding.

A ring network 20 may include nodes 22 coupled by fibers 26 in a ring topology. Ring network 20 may have any suitable topology, for example, a unidirectional path-switched ring (UPSR) topology or a bidirectional line switched ring (BLSR) topology. According to one embodiment, ring network 20 may comprise an optical fiber ring.

Ring network 20 may utilize protocols such as Resilient Packet Ring (RPR) protocols. An RPR protocol may refer to a protocol for ring-based packet transport, where packets are added, passed through, or dropped at each node 22. According to one embodiment, ring network 20 may utilize any suitable transmission technique, such as Ethernet, Synchronous Optical Network (SONET), or wavelength division multiplexing (WDM) (such as dense wavelength division multiplexing (DWDM)) techniques.

A path, or circuit, may refer to a sequence of nodes 22 through which an optical signal may travel. Example path types include unidirectional, bidirectional, drop and continue, broadcast, or multicast path types. Path information may refer to information describing one or more paths. As an example, path information may describe the sequence of nodes 22 included in a path.

In one example, a path may comprise endpoint nodes 22 and a set of zero or more intermediate nodes 22 between the endpoint nodes 22. Endpoint nodes 22 may include an initiating node 22 and a terminating node 22. An initiating node 22 may refer to a node 22 at which a message enters network system 10, and a terminating node 22 may refer to a node 22 at which the message exits network system 10. Accordingly, a message may travel from an initiating node 22, through the zero or more intermediate nodes 22, to a terminating node 22.

An endpoint node 22 may be identified in any suitable manner. According to one embodiment, a node 22 may be identified as an endpoint node 22 if the node 22 is a network facility, if the node 22 comprises a WDM interface that has no neighbor node 22, or if the node 22 does not have a provisioned cross connect 28.

A node 22 may route a packet to a next node 22 of the path according to the destination address of the packet. Typically, the destination address specifies a node identifier, such as an Internet Protocol (IP) address, that uniquely identifies a destination node 22. A node 22 may have a table that specifies an output port for a given destination address.

A node 22 may include any suitable components. According to the illustrated embodiment, a node 22 may include a network element 24, a cross connect 28, a database 32, and/or a regenerating unit 38. A network element 24 may represent any suitable device operable to route packets to or from ring network 20. Examples of network elements 24 include dense wavelength division multiplexers (DWDMs), access gateways, endpoints, softswitch servers, trunk gateways, access service providers, Internet service providers, or other device operable to route packets to or from ring network 20.

A cross connect 28 may represent a coupling device that couples connecting hardware on each end. Cross connect 28 may be incorporated with or separate from network element 24. According to one embodiment, cross connect 28 may include information generated at the management plane that may be used to generate path information describing a path. In the embodiment, cross connect 28 may map a specific input port to a specific output port such that a packet received at the input port is routed to the output port. The mappings from cross connects 28 of an optical path may be used to generate path information describing the path, which may provide control plane information to manage the paths end-to-end.

A database 32 may represent a device operable to store link state information, for example, a link state database (LSDB). Link state information describes the links and paths of network system 10.

A regenerating node 22, such as node B, may perform signal regeneration. According to the illustrated embodiment, regenerating node 22 includes a regenerator unit 38 that regenerates signals in any suitable manner. As an example, an amplifying regenerator unit may re-amplify a signal to regenerate the signal. As another example, an optical-electrical-optical (O-E-O) regenerator unit may convert an optical signal to an electrical signal, process the electrical signal to regenerate the signal, then convert the electrical signal back to an optical signal.

According to the embodiment, a node 22 receives a path message 42 communicating optical signal regeneration information for a path. If path message 42 indicates that node 22 is a regenerating node 22, node 22 configures itself to perform signal regeneration for the path.

Traffic 40 may travel in a particular direction of a path. According to the illustrated example, traffic 40 flows from node C through node B to node A. A traffic ingress node 22 may refer to a node 22 at which traffic enters network system 10, and a traffic egress node 22 may refer to a node 22 at which the traffic exits network system 10. Packets may travel in a direction that is reverse of the direction of traffic. A reverse traffic ingress node 22 may refer to a node 22 at which a reverse packet enters network system 10, and a reverse traffic egress node 22 may refer to a node 22 at which the reverse packet exits network system 10.

Fibers 36 may refer to any suitable fiber operable to transmit a signal. According to one embodiment, a fiber 36 may represent an optical fiber. An optical fiber typically comprises a cable made of silica glass or plastic. The cable may have an outer cladding material around an inner core. The inner core may have a slightly higher index of refraction than the outer cladding material. The refractive characteristics of the fiber operate to retain a light signal inside of the fiber.

A ring network 20 may have any suitable number of fibers 36, for example, two fibers 36. As an example, the first fiber 36 traverses a ring network 20 in one direction, and the second fiber traverses ring network 20 in the other direction. A ring segment may refer to the portion of fibers 36 between network elements 24, and may be designated by the specific ports of network elements coupled by the ring segment.

According to one embodiment, a regeneration information module 14 may generate optical signal recognition information. Module 14 may be associated with, such as be a part of, a node 22. Optical signal regeneration information, or regeneration information, may refer to information that may be used to configure an optical network for optical signal regeneration. For example, regeneration information may be used to configure regenerating nodes 22 to perform optical signal regeneration.

Regeneration information may include any suitable information. According to one embodiment, regeneration information may include a regenerating node identifier. A regenerating node identifier may identify a particular node 22 as a regenerating node 22. A node 22 that receives the regeneration information may determine from the regenerating node identifier whether it is supposed to perform signal regeneration. A regenerating node identifier may identify a regenerating node 22 by providing the hop and/or IP address corresponding to the regenerating node 22. According to the embodiment, a regenerating node 22 may identify regenerator units using a table lookup.

According to another embodiment, regeneration information may include a regenerator unit identifier in addition to a regenerating node identifier. A regenerator unit identifier identifies a regenerating unit 38 that a regenerating node 22 may use to perform signal regeneration. A regenerator unit identifier may comprise one or more management plane identifiers for the regenerator unit 38, such as identifiers that provide the location and/or identification of the regenerator unit 38. As an example, a regenerator unit identifier may identify the line cards of a regenerating node to use for regeneration.

According to one embodiment, regeneration information may include information for configuring a path in a forward direction and for configuring the path in a reverse direction. That is, regenerating nodes and/or regenerator units may be identified for the forward direction, and regenerating nodes and/or regenerator units may be identified for the reverse direction.

According to one embodiment of operation, a path message 42 communicates the regeneration information through a path. Path message 42 may be sent using an out-of-band signal over the control plane. According to the embodiment, the regeneration information may be at initiating node 22 of a path during setup of the path. The regeneration information may be included in path message 42.

Path message 42 may be sent from initiating node 22, through zero or more intermediate nodes 22, to terminating node 22. Path message 42 may travel in any suitable direction through nodes 22, for example, in the direction of the flow of traffic 40 or opposite to the direction of the flow of traffic 40. According to one embodiment, a path message 42 travels in a direction opposite the flow of traffic 40. That is, path message 42 may be sent from a reverse ingress node 22, through one or more intermediate nodes 22, to a reverse egress node 22.

Nodes 22 receive path message 42. A node 22 identified as a regenerating node 22 configures itself to perform signal regeneration. According to one embodiment, node 22 may configure signal regeneration for the forward direction and the reverse direction. According to another embodiment, node 22 may configure signal regeneration for the forward direction using path message 42, and may configure signal regeneration for the reverse direction according to regeneration information sent in a return message 44.

The regeneration information may be placed in path message 42 in any suitable manner. According to one embodiment, the regeneration information for a path may be specified using explicit source route of the path. The source route may be specified by a source route list of the nodes 22 and/or links of the path. The regeneration information may be added as to the list as an attribute providing regenerating node identifiers and/or regenerator unit identifiers.

The path and return messages may perform other operations in addition to communication regeneration information. In one example, path message 42 gathers path information as it passes through nodes 22 from an initiating node 22 to a terminating node 22. Terminating node 22 collects the gathered path information, and sends the path information back to initiating node 22 in return message 44. The path information may be stored at databases 32 of initiating node 22.

In another example, the path and return messages may be used to reserve resources, for example, bandwidth. For example, the path message may comprise an RSVP path message, and the return message may comprise an RSVP reservation-request message. In the example, the path messages may describe requested resources, for example, bandwidth requirements and parameters of data to be sent. The path messages are propagated from an initiating node 22 through intermediate nodes 22 to terminating nodes 22. Each terminating node 22 interested in the data confirms the flow by sending a reservation-request message through the network. The reservation-request message describes the bandwidth characteristics of the data to be received from the initiating node 22.

As the reservation-request messages propagate back towards the initiating node 22, intermediate nodes 22 determine whether or not to accept the proposed reservation and commit resources based on their capacity. If an intermediate node 22 decides to accept the proposed reservation, the resources are committed and the reservation-request message is propagated to a next node 22 in the path.

Modifications, additions, or omissions may be made to network system 10 without departing from the scope of the invention. The components of network system 10 may be integrated or separated according to particular needs. Moreover, the operations of network system 10 may be performed by more, fewer, or other devices. Additionally, operations of network system 10 may be performed using any suitable logic. As used in this document, “each” refers to each member of a set or each member of a subset of a set.

FIG. 2 is a flowchart illustrating one embodiment of a method for providing optical signal regeneration information that may be used with network system 10 of FIG. 1. The method begins at step 110, where a path setup process is initiated. A path setup process may be initiated in order to establish an optical path through network system 10.

Source route information describing the path is generated at step 114. The source route information may include a list of links and/or nodes 22 of the path. Optical signal regeneration information is included in the source route information at step 118. Regeneration information may specify optical signal regeneration for the path. As an example, regeneration information may identify regenerating nodes 22 and regenerator units 38 that may be used by the regenerating nodes 22.

The source route information is inserted into path message 42 at step 122. The information may be inserted into path message 42 at initiating node 22. Path message 42 is sent to a next node at step 126.

The next node 22 may be a regenerating node 22 at step 134. Node 22 may identify itself as a regenerating node 22 according to the regeneration information of the path message 42. As an example, the regeneration information may include a regenerating node identifier that identifies node 22 as a regenerating node 22. If the node 22 is a regenerating node at step 134, the method proceeds to step 138.

Regenerating node 22 identifies a regenerating unit 38 at step 138. Regenerating node 22 may identify regenerating unit 38 from a regenerating unit identifier given by the regeneration information. The method then proceeds to step 142. If node 22 is not a regenerating node at step 134, the method proceeds directly to step 142.

Node 22 may be a terminating node at step 142. If node 22 is not a terminating node at step 142, the method returns to step 126 where path message 42 is sent to a next node 22. If node 22 is a terminating node 22 at step 142, the method proceeds to step 146. Terminating node 22 receives path message 42 at step 146. After receiving path message 42 at step 146, the method ends.

Modifications, additions, or omissions may be made to the method without departing from the scope of the invention. The method may include more, fewer, or other steps. Additionally, steps may be performed in any suitable order without departing from the scope of the invention.

Certain embodiments of the invention may provide one or more technical advantages. A technical advantage of one embodiment may be that optical signal regeneration information may be provided at the control plane. Providing the regeneration information at the control plane may be more efficient than providing the regeneration information at the management plane.

A technical advantage of another embodiment may be that the regeneration information for the regenerating nodes of an optical signal path may be provided at an initiating node of the path. A path message may communicate the regeneration information from the initiating node to each regenerating node. Providing the regeneration information at the initiating node may be more efficient than providing the information at each regenerating node.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

What is claimed is:

1. A method for providing optical signal regeneration information for an optical path, comprising:
sending a path message through an optical path comprising a sequence of nodes of a communication network, the sequence of nodes comprising an initiating node, a set of intermediate nodes, and a terminating node, the path message communicating optical signal regeneration information, the optical signal regeneration information specifying optical signal regeneration for one or more regenerating nodes of the sequence of nodes; and
performing the following for each regenerating node of the one or more regenerating nodes:
receiving the path message at the each regenerating node; and
configuring the each regenerating node according to the optical signal regeneration information, the configured regenerating node operable to perform optical signal regeneration.

2. The method of claim 1, further comprising:
establishing the optical signal regeneration information at the initiating node; and
including the optical signal regeneration information in the path message at the initiating node.

3. The method of claim 1, wherein the optical signal regeneration information further comprises:
one or more regenerating node identifiers, a regenerating node identifier identifying a regenerating node of the one or more regenerating nodes.

4. The method of claim 1, wherein the optical signal regeneration information further comprises:
one or more regenerator unit identifiers, a regenerator unit identifier identifying a regenerator unit operable to regenerate an optical signal for a regenerating node of the one or more regenerating nodes.

5. The method of claim 1, wherein the optical signal regeneration information further comprises:
optical signal regeneration information for a forward direction of the optical path; and
optical signal regeneration information for a reverse direction of the optical path.

6. The method of claim 1, wherein:
the path message comprises a source route list; and
the optical signal regeneration information is provided as an attribute to the list.

7. The method of claim 1, wherein:
the path message comprises a Resource Reservation Protocol (RSVP) path message.

8. A system for providing optical signal regeneration information for an optical path, comprising:
a module operable to:
send a path message through an optical path comprising a sequence of nodes of a communication network, the sequence of nodes comprising an initiating node, a set of intermediate nodes, and a terminating node, the path message communicating optical signal regeneration information; and
one or more regenerating nodes of the sequence of nodes, the optical signal regeneration information specifying optical signal regeneration for the one or more regenerating nodes, each regenerating node of the one or more regenerating nodes operable to:
receive the path message; and
configure itself according to the optical signal regeneration information, the configured regenerating node operable to perform optical signal regeneration.

9. The system of claim 8, the module further operable to:
establish the optical signal regeneration information at the initiating node; and
include the optical signal regeneration information in the path message at the initiating node.

10. The system of claim 8, wherein the optical signal regeneration information further comprises:
one or more regenerating node identifiers, a regenerating node identifier identifying a regenerating node of the one or more regenerating nodes.

11. The system of claim 8, wherein the optical signal regeneration information further comprises:
one or more regenerator unit identifiers, a regenerator unit identifier identifying a regenerator unit operable to regenerate an optical signal for a regenerating node of the one or more regenerating nodes.

12. The system of claim 8, wherein the optical signal regeneration information further comprises:
optical signal regeneration information for a forward direction of the optical path; and
optical signal regeneration information for a reverse direction of the optical path.

13. The system of claim 8, wherein:
the path message comprises a source route list; and
the optical signal regeneration information is provided as an attribute to the list.

14. The system of claim 8, wherein:
the path message comprises a Resource Reservation Protocol (RSVP) path message.

15. A method for providing optical signal regeneration information for an optical path, comprising:
sending a path message through an optical path comprising a sequence of nodes of a communication network, the sequence of nodes comprising an initiating node, a set of intermediate nodes, and a terminating node, the path message communicating optical signal regeneration information, the optical signal regeneration information specifying optical signal regeneration for one or more regenerating nodes of the sequence of nodes, each regenerating node of the one or more regenerating nodes operable to:
receive the path message at the each regenerating node; and
configure the each regenerating node according to the optical signal regeneration information, the configured regenerating node operable to perform optical signal regeneration.

16. The method of claim 15, further comprising:
establishing the optical signal regeneration information at the initiating node; and
including the optical signal regeneration information in the path message at the initiating node.

17. The method of claim 15, wherein the optical signal regeneration information further comprises:
one or more regenerating node identifiers, a regenerating node identifier identifying a regenerating node of the one or more regenerating nodes.

18. The method of claim 15, wherein the optical signal regeneration information further comprises:
one or more regenerator unit identifiers, a regenerator unit identifier identifying a regenerator unit operable to regenerate an optical signal for a regenerating node of the one or more regenerating nodes.

19. The method of claim 15, wherein the optical signal regeneration information further comprises:
optical signal regeneration information for a forward direction of the optical path; and
optical signal regeneration information for a reverse direction of the optical path.

20. The method of claim 15, wherein:
the path message comprises a source route list; and
the optical signal regeneration information is provided as an attribute to the list.

21. The method of claim 15, wherein:
the path message comprises a Resource Reservation Protocol (RSVP) path message.

22. A system for providing optical signal regeneration information for an optical path, comprising:
means for sending a path message through an optical path comprising a sequence of nodes of a communication network, the sequence of nodes comprising an initiating node, a set of intermediate nodes, and a terminating node, the path message communicating optical signal regeneration information, the optical signal regeneration information specifying optical signal regeneration for one or more regenerating nodes of the sequence of nodes; and
means for performing the following for each regenerating node of the one or more regenerating nodes:
receiving the path message at the each regenerating node; and
configuring the each regenerating node according to the optical signal regeneration information, the configured regenerating node operable to perform optical signal regeneration.

23. A system for providing optical signal regeneration information for an optical path, comprising:
a module operable to:
establish optical signal regeneration information for an optical path comprising a sequence of nodes of a communication network, the sequence of nodes comprising an initiating node, a set of intermediate nodes, and a terminating node, the optical signal regeneration information established at the initiating node;
include the optical signal regeneration information in the path message at the initiating node; and
send the path message through the optical path, the path message communicating the optical signal regeneration information, the path message comprising a source route list, the optical signal regeneration information provided as an attribute to the list, the path message comprising a Resource Reservation Protocol (RSVP) path message; and
one or more regenerating nodes of the sequence of nodes, the optical signal regeneration information specifying optical signal regeneration for the one or more regenerating nodes, the optical signal regeneration information comprising:
one or more regenerating node identifiers, a regenerating node identifier identifying a regenerating node of the one or more regenerating nodes;
one or more regenerator unit identifiers, a regenerator unit identifier identifying a regenerator unit operable to regenerate an optical signal for a regenerating node of the one or more regenerating nodes;
optical signal regeneration information for a forward direction of the optical path; and
optical signal regeneration information for a reverse direction of the optical path, each regenerating node of the one or more regenerating nodes operable to:
receive the path message; and
configure itself according to the optical signal regeneration information, the configured regenerating node operable to perform optical signal regeneration.
